(19) United States
(12) Patent Application Publication
(10) Pub. No.: US 2006/0119714 A1
(43) Pub. Date: Jun. 8, 2006

(54) Data processor and data processing method

(75) Inventors: Asako Tamura, Kanagawa (JP); Hideo Miyamaki, Tokyo (JP); Satoshi Tabuchi, Kanagawa (JP); Masaharu Suzuki, Kanagawa (JP); Hiroshi Hibi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/268,587

(22) Filed: Nov. 8, 2005

(30) Foreign Application Priority Data
Nov. 17, 2004 (JP) P2004-333698

(51) Int. Cl. H04N 5/76

(52) U.S. Cl. 348/240.99; 348/231.2

(57) ABSTRACT

The present invention extracts picked up image data picked up by a specialized apparatus and converts the extracted picked up image data into a data format capable of being handled in a general apparatus. The present invention provides a data processor including a setting section that sets an extraction condition for extracting an arbitrary frame from a database that stores a frame including picked up image data and meta data containing imaging information corresponding to the picked up image data, a specifying section that specifies an arbitrary location on a recording medium capable of recording data, an extraction section that extracts an arbitrary frame from the database according to the extraction condition set by the setting section, a conversion section that converts the picked up image data and meta data containing imaging information corresponding to the picked up image data which are included in the frame extracted by the extraction section into a predetermined data format, and a storage section that stores the picked up image data and meta data containing imaging information corresponding to the picked up image data that have been converted into a predetermined format by the conversion section in the arbitrary location specified by the specifying section, wherein the setting section sets the imaging information contained in the meta data as the extraction condition.

### CROSS REFERENCE TO RELATED APPLICATIONS

The present invention contains subject matter related to Japanese Patent Application JP 2004-333698 filed in the Japanese Patent Office on Nov. 17, 2004, the entire contents of which being incorporated herein by reference.

### BACKGROUND OF THE INVENTION

1. Field of the Invention

The present invention relates to a data processor and a data processing method that convert data obtained by using a sensor camera to perform wide-angle imaging while using a zoom camera to take an image of a subject to be tracked in the imaging area of the sensor camera into a predetermined file format and save it.

2. Description of the Related Art

An electronic still camera, which has been widely used, is configured to: take an image of a subject to convert a light transmitted through a lens into an image signal by a solid-state image sensing device such as a CCD; record the image signal onto a recording medium; and reproduce the recorded image signal. A number of electronic still cameras have a monitor capable of displaying the imaged still image, on which recorded still images can selectively be displayed.

In this electronic still camera, the image signal to be supplied to the monitor corresponds to a subject for each screen, so that image area to be displayed at a time is limited, making it impossible to monitor the condition of a wide area at once.

Under the circumstances, a monitoring camera capable of monitoring the condition of a wide area is now in widespread use, in which a subject is imaged with the imaging direction of a camera sequentially shifted to obtain a panoramic entire image constituted by a plurality of unit-images. Particularly, in recent years, a technique of contracting/synthesizing a plurality of video signals into a video signal corresponding to one frame has been proposed (refer to, for example, Jpn. Pat. Appln. Laid-Open Publication No. 10-108163). Further, a centralized monitoring recording system which realizes a monitoring function by acquiring monitoring video images from a plurality of set up monitoring video cameras and recording them onto a recording medium such as a video tape has been proposed (refer to, for example, Jpn. Pat. Appln. Laid-Open Publication No. 2000-243062).

### SUMMARY OF THE INVENTION

The individual image to be recorded in the recording medium as described above is saved in a single file (hereinafter, referred to as image data file) together with meta-data such as imaging time or angle of view. Based on the image data file, the centralized monitoring recording system performs synchronous reproduction of the images taken by a plurality of cameras and selects one image during reproduction so as to export the image as a single still image.

However, the abovementioned image data file uses a unique format to the centralized monitoring recording system and, accordingly, can be handled only in the centralized monitoring recording system. Thus, the image data file used in the centralized monitoring recording system is lacking in versatility.

Further, in the monitoring system that performs recording operation in a constant manner, data amount becomes enormous. Thus, there may arise a need to export only the image data file (for example, image in which there has been a change) meaningful to a user from the saved image data files. In this case, a user selects the image to be exported one by one while browsing a monitor in a conventional system. However, it is more convenient that the system mechanically export images according to a given condition.

Therefore, the present invention provides a data processor and data processing method capable of exporting an image data file that has been read according to a given condition to a data file using a versatile format.

To solve the above problem, according to the present invention, there is provided a data processor including: a setting means for setting an extraction condition for extracting an arbitrary frame from a database that stores a frame including picked up image data and meta data containing imaging information corresponding to the picked up image data; a specifying means for specifying an arbitrary location on a recording medium capable of recording data; an extraction means for extracting an arbitrary frame from the database according to the extraction condition set by the setting means; a conversion means for converting the picked up image data and meta data containing imaging information corresponding to the picked up image data which are included in the frame extracted by the extraction means into a predetermined data format; and a storage means for storing the picked up image data and meta data containing imaging information corresponding to the picked up image data that have been converted into a predetermined format by the conversion means in the arbitrary location specified by the specifying means, wherein the setting means sets the imaging information contained in the meta data as the extraction condition.

The setting means sets information relating to an imaging device that picks up the picked up image data corresponding to the meta data as the extraction condition.

The setting means sets information relating to date and time when the picked up image data corresponding to the meta data was picked up as the extraction condition.

The conversion means converts the picked up image data into JPEG (Joint Photographic Experts Group) format and converts the meta data corresponding to the picked up image data into XML (extensible markup language) format.

The data processor according to the present invention further includes: a sensor camera that performs wide-angle imaging; a moving object detection means for detecting a moving object in the picked up image data picked up by the sensor camera; a zoom camera that enlarges the moving object detected by the moving object detection means and picks up the enlarged moving object; and a storage means for storing, in units of frame, picked up image data picked up by the sensor camera, meta data containing imaging information corresponding to the picked up image data, picked up image data picked up by the zoom camera, and meta data containing imaging information corresponding to the picked up image data in the database.

According to the present invention, there is provided a data processing method including the steps of: setting an extraction condition for extracting an arbitrary frame from an image database that stores a frame including picked up image data and meta data containing imaging information corresponding to the picked up image data; specifying an arbitrary location on a recording medium capable of recording data; extracting an arbitrary frame from the database according to the extraction condition set in the setting step; converting the picked up image data and meta data containing imaging information corresponding to the picked up image data which are included in the frame extracted in the extraction step into a predetermined data format; and storing the picked up image data and meta data containing imaging information corresponding to the picked up image data that have been converted into a predetermined format in the conversion step in the arbitrary location specified by the specifying step, wherein the setting step sets the imaging information contained in the meta data as the extraction condition.

The setting step sets information relating to an imaging device that picks up the picked up image data corresponding to the meta data as the extraction condition.

The setting step sets information relating to date and time when the picked up image data corresponding to the meta data was picked up as the extraction condition.

The conversion step converts the picked up image data into JPEG (Joint Photographic Experts Group) format and converts the meta data corresponding to the picked up image data into XML (extensible markup language) format.

The data processing method according to the present invention further includes: a first imaging step that uses a sensor camera to perform wide-angle imaging; a moving object detection step that detects a moving object in the picked up image data picked up by the first imaging step; a second imaging step that uses a zoom camera to enlarge the moving object detected in the moving object detection step and picks up the enlarged moving object; and a storage step that stores, in units of frame, picked up image data picked up in the first imaging step, meta data containing imaging information corresponding to the picked up image data picked up in the first imaging step, picked up image data picked up in the second imaging step, and meta data containing imaging information corresponding to the picked up image data picked up in the first imaging step in the database.

According to the present invention, in a state where the wide angle image data and enlarged image data obtained by enlarging and picking up a moving object in the wide angle image data are stored, in units of frame, in the database by the specialized monitoring apparatus together with the meta data associated respectively with the wide angel image data and enlarged image data, it is possible to extract only desired enlarged image data from enormous amount of monitoring data stored in the database. Further, the extracted data and meta data associated with it are converted into a versatile data format, so that the image data picked up for monitoring can easily be handled in apparatuses other than the specialized apparatus. Further, it is possible to save the storage capacity of the recording medium for storing the extracted data by limiting the time period or condition according to which the data stored in the database is extracted.

### BRIEF DESCRIPTION OF THE DRAWINGS

FIG. 1 is a block diagram showing a configuration of an imaging processor according to the present invention;

FIG. 2 is a block diagram showing a configuration of an image pickup section included in the imaging processor according to the present invention;

FIG. 3 is a first flowchart for explaining operation of a storage section shown in FIG. 2;

FIG. 4 is a second flowchart for explaining operation of the storage section shown in FIG. 2;

FIG. 5 is a third flowchart for explaining operation of the storage section shown in FIG. 2;

FIG. 6 is a view showing a data format adopted in the imaging processor according to the present invention;

FIG. 7 is a block diagram showing a configuration of a data processing section included in the imaging processor according to the present invention;

FIG. 8 is a flowchart for explaining the determination procedure of an extraction condition according to which the data processing section included in the imaging processor according to the present invention extracts an arbitrary frame from a database;

FIG. 9 is a flowchart for explaining the procedure of extracting an arbitrary frame from the database according to the extraction condition determined using the flowchart of FIG. 8;

FIG. 10 is a view showing the source code of XML format;

FIG. 11 is a view for explaining an example of an output file; and

FIG. 12 is a view showing an example in which the data that has been converted into a versatile format is displayed on a Web browser.

### DETAILED DESCRIPTION OF THE PREFERRED EMBODIMENTS

An embodiment of the present invention will be described below in detail with reference to the accompanying drawings.

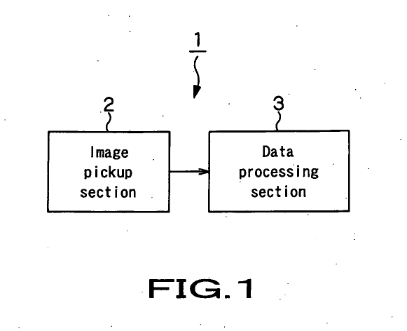

As shown in FIG. 1, an imaging processor 1 includes an image pickup section 2 that picks up an image of a subject and stores the picked up data and a data processing section 3 that processes the data picked up by the image pickup section 2.

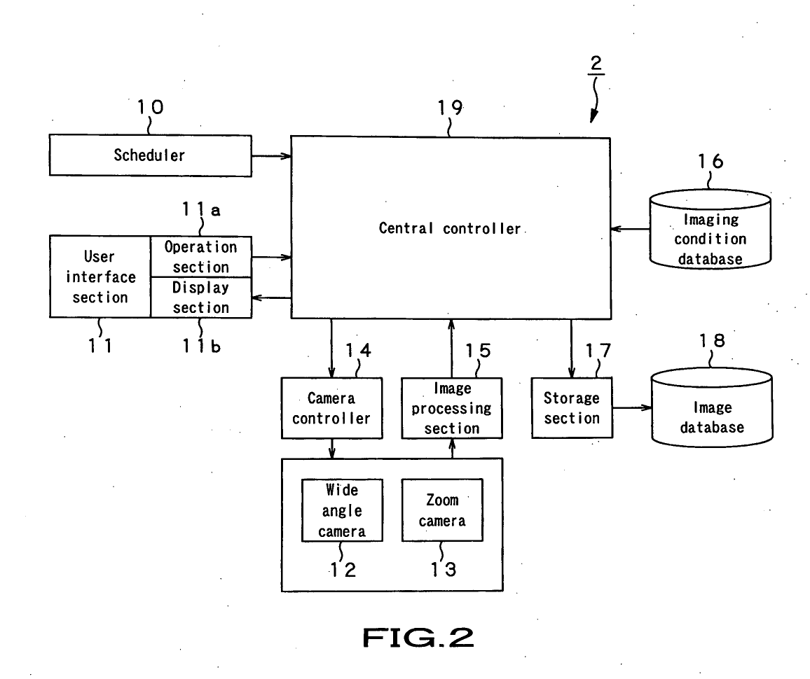

As shown in FIG. 2, the image pickup section 2 has: a scheduler 10 that manages an execution schedule of photographing and recording; a user interface section 11 including an operation section 11a that generates an operation signal in response to user's operation and a display section 11b; a camera controller 14 that controls a wide angle camera 12 that performs wide angle imaging and a zoom camera 13 that enlarges (zooms) one image area that is being picked up by the wide angle camera 12 and picks up the enlarged image; an image processing section 15 that applies predetermined processing to the image that has been picked up by the wide angle camera 12 and zoom camera 13; an imaging condition data base 16 that stores an imaging condition; a storage section 17 that stores the image picked up by the cameras 12 and 13 in an image database 18; and a central controller 19 that performs a predetermined computation.

A description will be given of operation of the image pickup section 2. The image pickup section 2 allows a user to manually pick up a subject using the wide angle camera 12 and zoom camera 13 through the operation section 11a. Alternatively, the image pickup section 2 uses the wide angle camera 12 and zoom camera 13 to pick up a subject according to a schedule that has previously been set in the scheduler 10. After that, the image pickup section 2 records the picked up image.

When receiving an imaging/recording instruction issued from the operation section 11a or scheduler 10, the central controller 19 acquires a necessary imaging parameter or a detection parameter from the imaging condition database and supplies the camera controller 14 and image processing section 15 with the parameter and instructs the camera controller 14 and image processing section 15 to start imaging and image processing, respectively.

The camera controller 14 performs imaging operation while setting the imaging parameters of the wide angle camera 12 and zoom camera 13 and controlling pan/tilt or the like thereof based on the supplied parameters and instruction. The image processing section 15 receives the image data from the wide angle camera 12, performs moving object detection processing, adds the processing result to the image data from the wide angle camera 12, and supplies the central controller 19 with the processed image data. The central controller 19 supplies the camera controller 14 with a predetermined signal corresponding to the moving object detection processing. The camera controller 14 drives the zoom camera 13 in response to the signal from the central controller 19.

The central controller 19 generates meta data, such as imaging parameter or imaging time, corresponding to the image data and detection data of the wide angle camera 12 and zoom camera 13 that the central controller 19 has received through the image processing section 15. The central controller 19 supplies only the display section with the image data and meta data at the imaging time; whereas it supplies the display section and storage section 17 with the image data and meta data at the recording time. The display section sequentially displays the supplied image data on camera display windows corresponding to the wide angle camera 12 and zoom camera 13 based on the meta data. The storage section 17 receives the image data to which the meta data is added, buffers the data, and combines a given amount of buffered data into a single file. The central controller 19 determines next imaging coordinates based on the motion detection result and instructs the camera controller 14 to perform imaging operation according to the determined coordinates. The above operation is repeated until a stop instruction has been issued from the operation section 11a and scheduler 10.

The wide angle camera 12 picks up, for example, the panoramic view of the area to be monitored. Hereinafter, data of an image picked up by the wide angle camera 12 is referred to as “wide angel image data”.

The zoom camera 13 performs imaging while enlarging one image area that is being picked up by the wide angle camera 12 in response to a drive signal supplied from the camera controller 14. Hereinafter, data of an image picked up by the zoom camera 13 is referred to as “enlarged image data”.

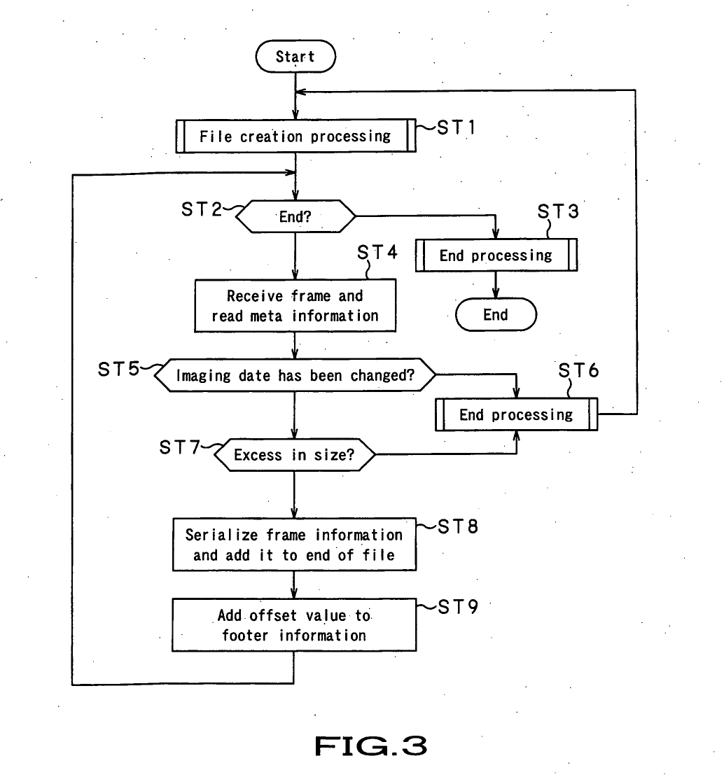

A description will next be given of operation of the storage section 17 with reference to the flowcharts shown in FIGS. 3 to 5.

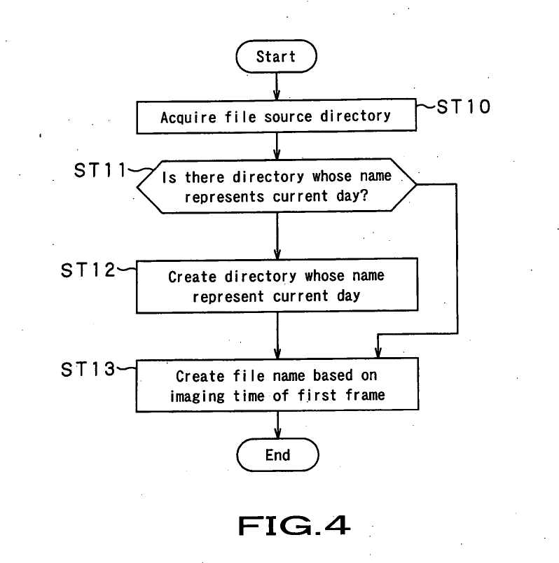

When receiving a data storage start instruction, the storage section 17 performs file creation processing (step ST1). As shown in FIG. 4, in the file creation processing, the storage section 17 acquires a file source directory (step ST10) and checks whether there is a directory whose name represents the current day in the file source directory (step ST11). If not, the storage section 17 creates a new directory whose name represents the current day (ST12). The storage section 17 then acquires data that is not changed from frame to frame, such as the imaging parameter, creates a file header, and creates an image data file name based on the imaging time of the first frame data that the storage section 17 has received (step ST13). The storage section 17 then waits a subsequent frame.

The storage section 17 determines whether to end the file creation processing (step ST2). When determining to end the file creation processing, the storage section 17 advances to an end processing step (step ST3). The end processing step will be described later.

When receiving frame data, the storage section 17 reads meta data included in the frame data (step ST4), checks whether the date of the imaging time has been changed or not. If changed, the storage section 17 performs file switch processing (step ST5) and then advances to an end processing step (step ST6). If not changed, the storage section 17 checks whether the total sum of the size of the meta data and that of the file being created exceeds a prescribed value (step ST7). When determining that the total sum of the data size has exceeded the prescribed value, the storage section 17 advances to the end processing step (step ST6); whereas when determining that the total sum of the data size has not exceeded the prescribed value, the storage section 17 serializes frame information including meta information, data size, and image data and adds it to a file (step ST8) and, at the same time, saves an offset value representing the start of the frame in the sequence.

The end processing step (step ST6) is the same as the abovementioned end processing step (step ST3). After the completion of the end processing step (step ST6), the storage section 17 returns to the file creation step (step ST1).

The storage section 17 adds the sequence representing the offset values of the respective frames and the total frame number to the end of the file (step ST9) and returns to step ST2.

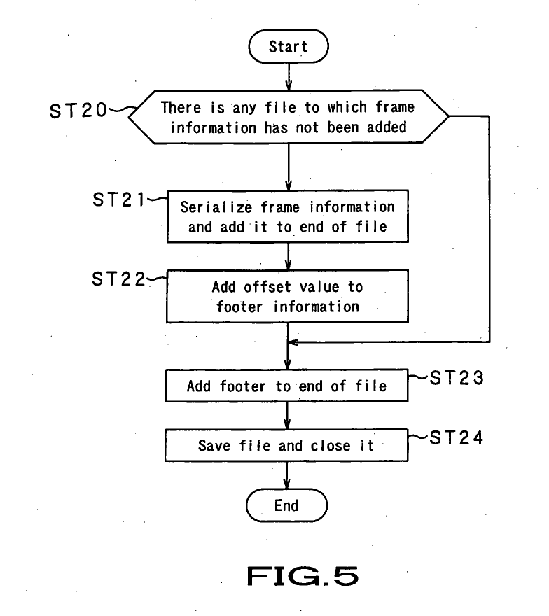

A description will be given of the end processing step (step ST3). As shown in FIG. 5, the storage section 17 determines whether there is any file to which the frame information has not been added (step ST20) in the case where the file creation processing is ended (step ST2), in the case where the date of the imaging time has been changed (step ST5), or in the case where the total sum of the data size has exceeded a prescribed value (step ST7). When determining that there is any file to which the frame information has not been added, the storage section 17 advances to step ST21. On the other hand, when determining that there is any file to which the frame information has not been added, the storage section 17 advances to step ST23.

The storage section 17 serializes the frame information including meta information, data size, and image data and adds it to a file (step ST21) and then adds a sequence representing the offset values of the respective frames and the total frame number to the end of the file (step ST22). The storage section 17 adds a footer to the end of the file that is being created (step ST23), stores the file in the image database 18 (step ST24) and ends this flow.

The storage section 17 assembles some large number (corresponding to, for example, 500 frames) of the filed image data and stores them in the image database 18. A predetermined name (hereinafter, referred to as file name) is assigned to each file and the name includes imaging date and time information. Thus, it is possible to recognize when the imaging was performed only by seeing the file name. The file name may include any information other than the imaging date and time as long as a user can distinguish the file by chronological order.

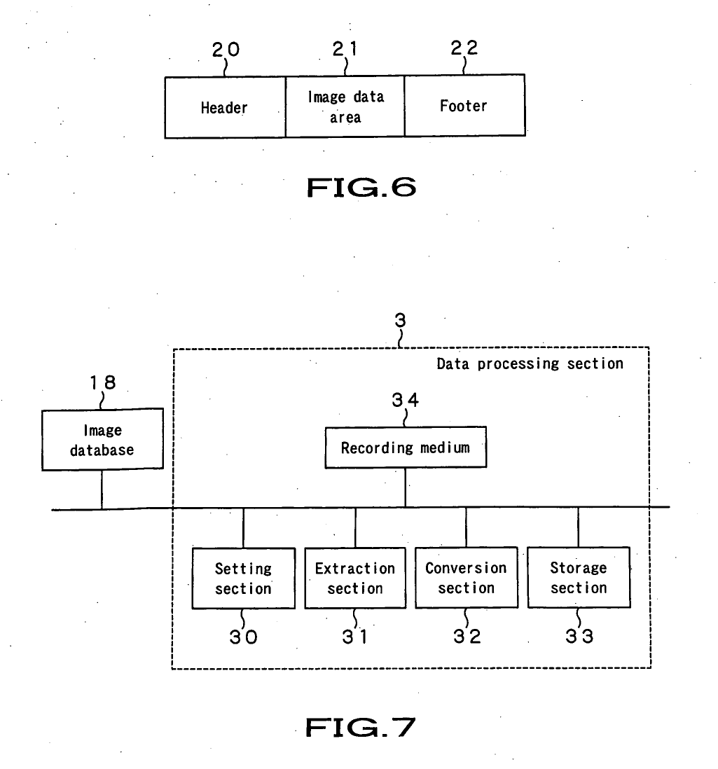

As shown in FIG. 6, each image data is stored in a data format constituted by a header 20, an image data area 21, and a footer 22. In the header 20, various parameters needed in the imaging time and data that is not changed with time, such as a parameter obtained when a moving object is detected are stored.

The image data area 21 is constituted by a sequence of framed data (meta data for each frame and frame image). Further, the imaging processor 1 according to the embodiment of the present invention holds, as the meta data for each frame, imaging time information, ID information that uniquely specifies a moving object, number information (information for identifying whether the image data is wide area image data or enlarged image data) of the camera that has been used for imaging operation, and the like. In the case of video data picked up by the zoom camera 13, the meta data may include information relating to the coordinate position in the image picked up by the wide angle camera 12. In the case of the video data picked up by the wide angle camera 12, the meta data may include information relating to the number of detected moving objects.

The footer 22 includes an index for accessing image data in the image data area 21.

As shown in FIG. 7, the data processing section 3 includes: a setting section 30 that sets, a condition for detecting an arbitrary frame from the image database 18 and position (path) information indicating the directory for data saving; an extraction section 31 that extracts an arbitrary frame from the image database 18 based on the condition set in the setting section 30; a conversion section 32 that converts image data included in the arbitrary frame that has been extracted in the extraction section 31 into a versatile data format (for example, JPEG (Joint Photographic Experts Group) format) and converts meta data into a versatile data format (for example, XML (extensible markup language) format); and a storage section 33 that stores the image data and meta data that have been converted into versatile data formats in the conversion section 32 in an arbitrary directory in a recording medium 34 based on the directory information set in the setting section 30.

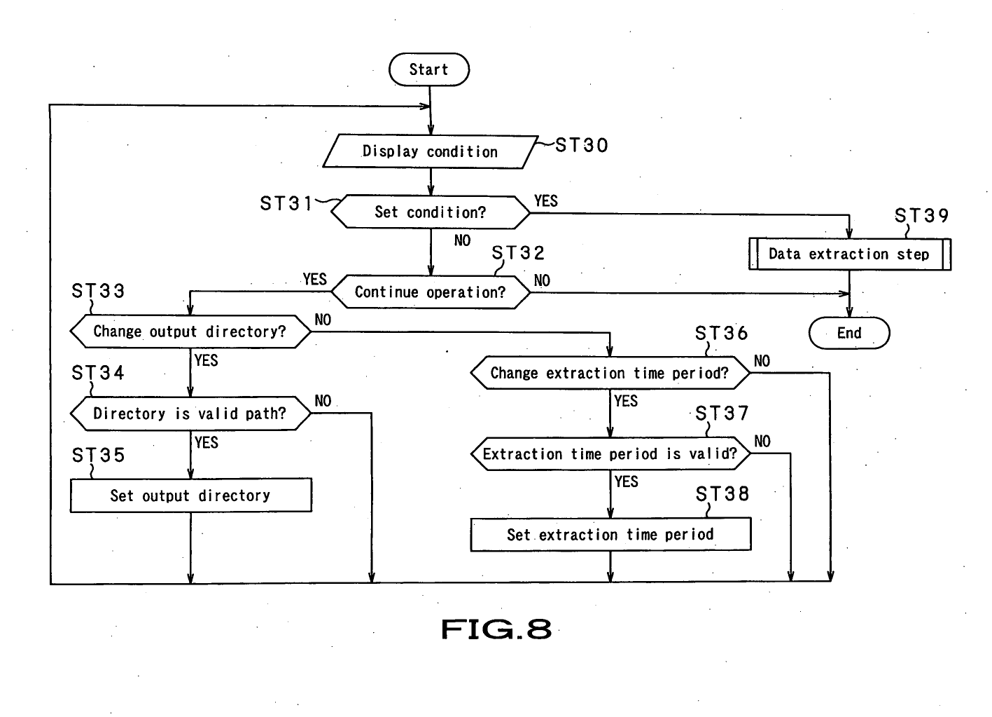

A description will be given of operation of the data processing section 3 with reference to the flowchart of FIG. 8. Here, the data processing section 3 sets the detection condition in the setting section 30.

In step ST30, the data processing section 3 displays, on the display section 17, information relating to the time period (start date and time to end date and time) according to which the frame stored in the image database 18 and information relating to the output directory. It is assumed that the data processing section 3 previously has “start date and time to end date and time” and output directory as default (initial setting).

In step S31, the data processing section 3 determines whether the condition displayed on the display section 17 is good or not. When determining the displayed condition is good, the data processing section 3 sets the extraction condition and advances to step ST39. In the case where the displayed condition needs to be changed, the data processing section 3 advances to step ST32.

In step ST32, the data processing section 3 determines whether to continue the operation. When determining to continue the operation, the data processing section 3 advances to step ST33.

In step ST33, the data processing section 3 determines whether to change the directory. When determining to change the directory, the data processing section 3 advances to step ST34. When determining not to change the directory, the data processing section 3 advances to step ST36.

In step ST34, the data processing section 3 determines whether the directory that has been changed in the step ST33 represents valid path or not. When determining that the directory represents a valid path, the data processing section 3 advances to step ST35. When determining that the directory is not valid, the data processing section 3 returns to step ST30.

In step ST35, the data processing section 3 sets the directory that has been changed in the step ST34 as the output directory and returns to step ST30.

In step ST36, the data processing section 3 determines whether to change the frame extraction time period (start date and time to end date and time). When determining to change the frame extraction time period, the data processing section 3 advances to step ST37. When determining not to change the frame extraction time period, the data processing section 3 returns to step ST30.

In step S37, the data processing section 3 determines whether the changed frame extraction time period is valid or not. For example, the data processing section 3 checks whether the start date and time is before the end time. When determining that the changed frame extraction time period is valid, the data processing section 3 advances to step ST38. When determining that the changed frame extraction time period is not valid, the data processing section 3 returns to step ST30.

In step S38, the data processing section 3 sets the frame extraction time period that has been changed in the step ST36 as the extraction time period and returns to step ST30.

In step S39, the data processing section 3 extracts an arbitrary frame from the image database 18 according to the extraction condition that has been set in the step ST31, converts the image data and meta data included in the extracted frame into versatile data formats, respectively, and stores the converted data in an arbitrary directory.

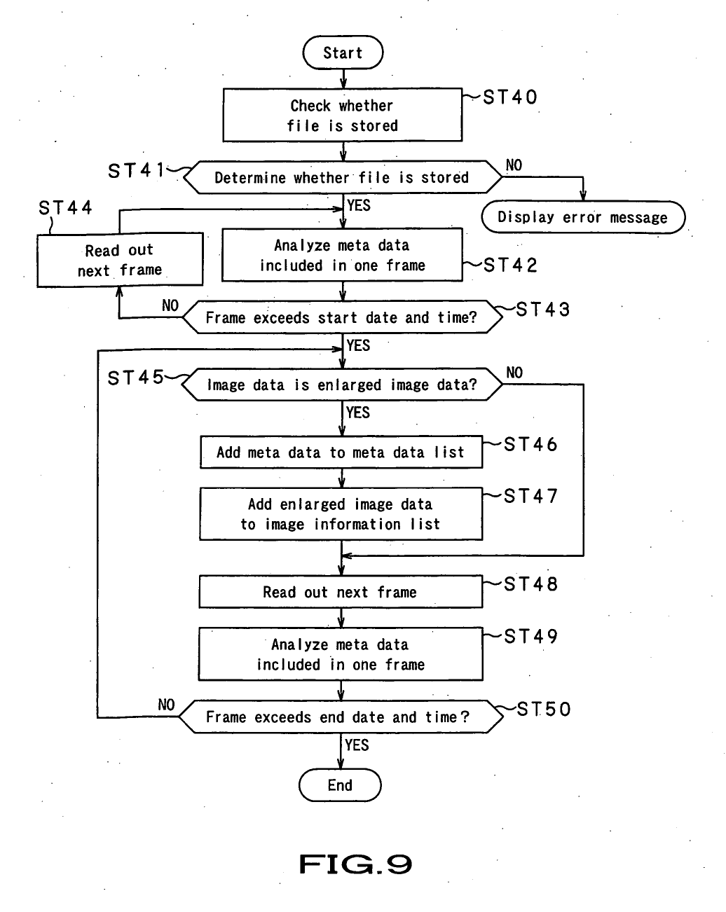

Details of the step ST39 will be described below with reference to the flowchart of FIG. 9.

In step ST40, the data processing section 3 checks whether any image file including target frames is stored in the image database 18.

In step ST41, the data processing section 3 determines whether any image file including target frames is stored in the image database 18 based on the result of step ST40. When determining that any image file including target frames is stored in the image database 18, the data processing section 3 advances to step ST42. When determining that any image file including target frames is not stored in the image database 18, the data processing section 3 notifies a user of that fact (by, for example, displaying an error message).

In step ST42, the data processing section 3 reads out one frame from the image file including target frames and analyzes the meta data included in the frame.

In step ST43, the data processing section 3 determines whether the frame corresponding to the analyzed meta data exceeds the start date and time set in step ST31 according to the analysis result obtained in the step ST42. When determining that the frame reaches or exceeds the start date and time, the data processing section 3 advances to step ST45. When determining that the frame does not reach the start date and time, the data processing section 3 advances to step ST44.

In step ST44, the data processing section 3 reads out the next one frame from the image file including target frames and returns to step ST42. The data processing section 3 repeats the steps ST42 to ST44 until one frame that has been read out from the image file including target frames has reached the start date and time set in the step ST31.

In step ST45, the data processing section 3 determines whether the image data included in the frame corresponding to the analyzed meta data is wide angle image data or enlarged image data based on the analysis result obtained in step ST42. When determining that the image data is wide angle image data, the data processing section 3 advances to step ST48. When determining that the image data is enlarged image data, the data processing section 3 advances to step ST46.

In step ST46, the data processing section 3 adds the meta data to a meta data list. If the meta data list to which the meta data is added has not yet been created, the data processing section 3 creates the meta data list and then adds the meta data to the created meta data list.

In step ST47, the data processing section 3 adds enlarged image data to an image information list. If the image information list has not yet been created, the data processing section 3 creates the image information list and then adds the enlarged image data to the created image information list.

In step ST48, the data processing section 3 reads out the next frame from the image file including target frames.

In step ST49, the data processing section 3 analyzes meta data included in the frame that has been read out in the step ST48.

In step ST50, the data processing section 3 determines whether the frame corresponding to the analyzed meta data exceeds the end date and time set in the step ST31 based on the analysis result obtained in the step ST49. When determining that the frame does not exceed the end date and time, the data processing section 3 returns to step ST45. When determining that the frame exceeds the end date and time, the data processing section 3 ends the entire process.

As described above, the data processing section 3 extracts frames including the enlarged image data within the start date and time to end date and time set in the step ST31 from the image database 18 and creates the meta data list and image information list relating to the enlarged image data.

The conversion section 32 coverts the meta data and image data into XML format and JPEG format which are versatile data formats based on the above meta data list and image information list relating to the enlarged image data.

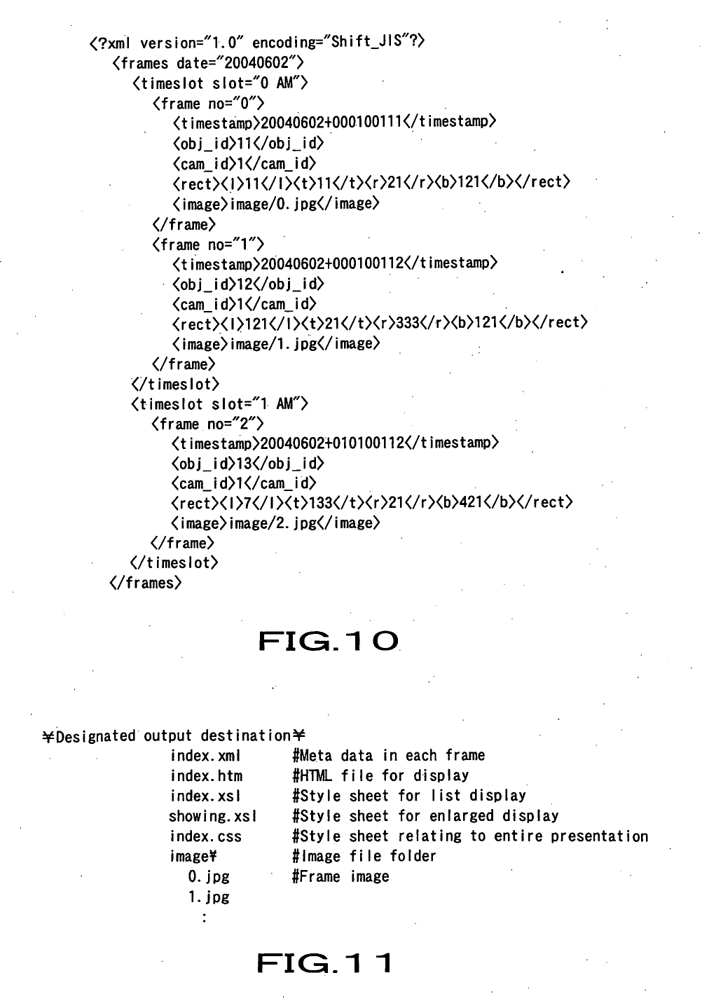

FIG. 10 shows meta data that has been converted into XML format. In FIG. 10, there are two enlarged image data picked up at 0 AM, and “0”, “1” are assigned to the two data respectively as frame numbers. Further, there is one enlarged image data picked up at 1 AM, and frame number “2” is assigned to the data. The enlarged image data (0.jpg) of frame number “0” is picked up on Jun. 2, 2004 by a camera whose ID is 1 (ID indicating the zoom camera 13), and “11” is assigned to the data as moving object ID (obj_id).

The enlarged image data (1.jpg) of frame number “1” is picked up on Jun. 2, 2004 by a camera whose ID is 1, and “12” is assigned to the data as moving object ID.

The enlarged image data (2.jpg) of frame number “2” is picked up on Jun. 2, 2004 by a camera whose ID is 1, and “13” is assigned to the data as moving object ID.

Further, imaging time (timestamp) and coordinate position of the enlarged image data (rect) are assigned to the respective picked up image data. The imaging time is assigned in association with the imaging date.

The storage section 33 stores the respective data converted in the conversion section 32 in the location specified by the directory set in the step ST31 (FIG. 11). FIG. 11 shows an example of an output file created in the case where the respective data that has been converted in the conversion section 32 are stored in the specified directory together with HTML file and style sheet for shaping/displaying the data such that a user can browse them on a browser (software for browsing Web pages).

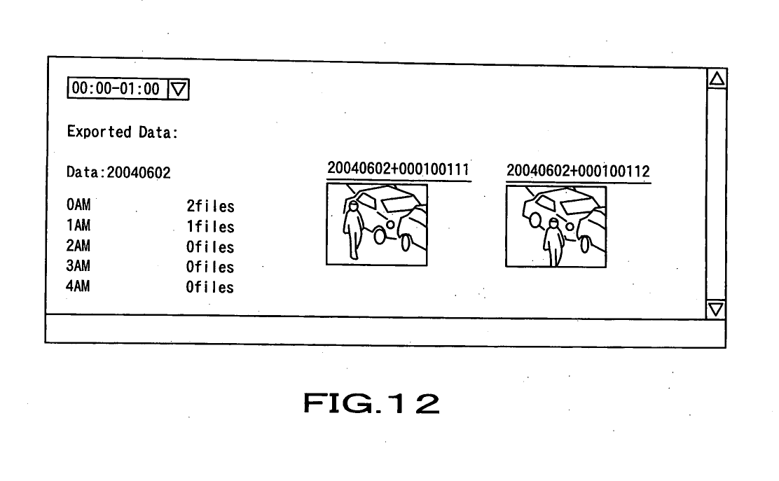

FIG. 12 shows a Web browser on which the data that has been converted as described above is displayed. In FIG. 12, a list of the number of picked up enlarged images tallied for each time zone and a list of images corresponding to selected time zone are displayed on the Web browser.

The imaging processor 1 having the above configuration has the data processing section 3 including: the setting section 30 that sets an arbitrary condition for extracting an arbitrary frame from the image database 18 that stores, in units of frame, the wide angle image data picked up by the wide angle camera 12 and enlarged image data obtained by picking up a moving object in the wide angle image data with the zoom camera 13 together with the meta data associated with them; the extraction section 31 that extracts an arbitrary frame from the image database 18 according to the condition set in the setting section 30; the conversion section 32 that converts the image data and meta data included in the frame extracted in the extraction section 31 into a versatile data format; and the storage section 33 that stores the data that has been converted in the conversion section 32 in an arbitrary directory in the recording medium 34 that has been set in the setting section 30. With the above configuration, it is possible to extract only desired enlarged image data from the enormous amount of data stored in the image database 18. Further, the extracted data and meta data associated with it are converted into a versatile data format, so that the image data picked up for monitoring can easily be handled in apparatuses other than a specialized apparatus. Further, the imaging processor 1 can save the storage capacity of the recording medium 34 by limiting the time period or condition according to which the data stored in the image database 18 is extracted.

Although, in the above described embodiment, description was made of a case where only the enlarged image data is extracted from the frame stored in the image database 18, it is possible to obtain a result other than one shown in FIG. 12 by setting another condition in the setting section 30. For example, the list may be created in view of the number of moving objects in the wide angle image data. In this case, frames are assorted in the descending order of the number of enlarged image data that each frame includes. Further, in view of the field of angle, the area in which the number of picked up images is large may be extracted (area in which the number of movements is large).

It should be understood by those skilled in the art that various modifications, combinations, sub-combinations and alternations may occur depending on design requirements and other factors insofar as they are within the scope of the appended claims or the equivalents thereof.

What is claimed is:

1. A data processor comprising:
setting means for setting an extraction condition for extracting an arbitrary frame from a database that stores a frame including picked up image data and meta data containing imaging information corresponding to the picked up image data;
specifying means for specifying an arbitrary location on a recording medium capable of recording data;
extraction means for extracting an arbitrary frame from the database according to the extraction condition set by the setting means;
conversion means for converting the picked up image data and meta data containing imaging information corresponding to the picked up image data which are included in the frame extracted by the extraction means into a predetermined data format; and
storage means for storing the picked up image data and meta data containing imaging information corresponding to the picked up image data that have been converted into a predetermined format by the conversion means in the arbitrary location specified by the specifying means, wherein
the setting means sets the imaging information contained in the meta data as the extraction condition.

2. The data processor according to claim 1, wherein the setting means sets information relating to an imaging device that picks up the picked up image data corresponding to the meta data as the extraction condition.

3. The data processor according to claim 1, wherein the setting means sets information relating to date and time when the picked up image data corresponding to the meta data was picked up as the extraction condition.

4. The data processor according to claim 1, wherein the conversion means converts the picked up image data into JPEG (Joint Photographic Experts Group) format and converts the meta data corresponding to the picked up image data into XML (extensible markup language) format.

5. The data processor according to claim 1, comprising:
a sensor camera that performs wide-angle imaging;
moving object detection means for detecting a moving object in the picked up image data picked up by the sensor camera;
a zoom camera that enlarges the moving object detected by the moving object detection means and picks up the enlarged moving object; and
storage means for storing, in units of frame, picked up image data picked up by the sensor camera, meta data containing imaging information corresponding to the picked up image data, picked up image data picked up by the zoom camera, and meta data containing imaging information corresponding to the picked up image data in the database.

6. A data processing method comprising the steps of:
setting an extraction condition for extracting an arbitrary frame from an image database that stores a frame including picked up image data and meta data containing imaging information corresponding to the picked up image data;
specifying an arbitrary location on a recording medium capable of recording data;
extracting an arbitrary frame from the database according to the extraction condition set in the setting step;
converting the picked up image data and meta data containing imaging information corresponding to the picked up image data which are included in the frame extracted in the extraction step into a predetermined data format; and
storing the picked up image data and meta data containing imaging information corresponding to the picked up image data that have been converted into a predetermined format in the conversion step in the arbitrary location specified by the specifying step, wherein
the setting step sets the imaging information contained in the meta data as the extraction condition.

7. The data processing method according to claim 6, wherein the setting step sets information relating to an imaging device that picks up the picked up image data corresponding to the meta data as the extraction condition.

8. The data processing method according to claim 6, wherein the setting step sets information relating to date and time when the picked up image data corresponding to the meta data was picked up as the extraction condition.

9. The data processing method according to claim 6, wherein the conversion step converts the picked up image data into JPEG (Joint Photographic Experts Group) format and converts the meta data corresponding to the picked up image data into XML (extensible markup language) format.

10. The data processing method according to claim 6, comprising:
a first imaging step that uses a sensor camera to perform wide-angle imaging;
a moving object detection step that detects a moving object in the picked up image data picked up by the first imaging step;
a second imaging step that uses a zoom camera to enlarge the moving object detected in the moving object detection step and pick up the enlarged moving object; and
a storage step that stores, in units of frame, picked up image data picked up in the first imaging step, meta data containing imaging information corresponding to the picked up image data picked up in the first imaging step, picked up image data picked up in the second imaging step, and meta data containing imaging information corresponding to the picked up image data picked up in the first imaging step in the database.

11. A data processor comprising:
a setting section that sets an extraction condition for extracting an arbitrary frame from a database that stores a frame including picked up image data and meta data containing imaging information corresponding to the picked up image data;
a specifying section that specifies an arbitrary location on a recording medium capable of recording data;
an extraction section that extracts an arbitrary frame from the database according to the extraction condition set by the setting section;
a conversion section that converts the picked up image data and meta data containing imaging information corresponding to the picked up image data which are included in the frame extracted by the extraction section into a predetermined data format; and
a storage section that stores the picked up image data and meta data containing imaging information corresponding to the picked up image data that have been converted into a predetermined format by the conversion section in the arbitrary location specified by the specifying section, wherein
the setting section sets the imaging information contained in the meta data as the extraction condition.
